(19) United States
(12) Patent Application Publication
(10) Pub. No.: US 2012/0229800 A1
(43) Pub. Date: Sep. 13, 2012

(54) PULSE OXIMETER TEST INSTRUMENTS AND METHODS

(75) Inventor: Tom West, Everett, WA (US)

(73) Assignee: FLUKE CORPORATION, Everett, WA (US)

(21) Appl. No.: 13/043,377

(22) Filed: Mar. 8, 2011

(51) Int. Cl. G01J 1/42

(52) U.S. Cl. 356/222

(57) ABSTRACT

Generally described, one or more embodiments of the present disclosure are directed to pulse oximeter test instruments and methods for testing pulse oximeters. The pulse oximeter test instruments may be configured to sense light at different wavelengths simultaneously. In some embodiments, light pulses having a wavelength above a particular threshold may be detected and used to test measurements made by a pulse oximeter. In that regard, the pulse oximeter test instruments disclosed herein are able to provide improved accuracy and more reliable test results over prior art pulse oximeter test instruments.

### BACKGROUND

Pulse oximeters are non-invasive medical devices configured to determine peripheral oxygen saturation (SpO₂). In particular, pulse oximeters measure a ratio of the optical absorption of two forms of hemoglobin, oxyhemoglobin and deoxyhemoglobin, in blood. The amount of absorption of hemoglobin measured in the blood may then be used to determine the peripheral oxygen saturation SpO₂.

Pulse oximeters operate on the principle of spectrophotometry, using wavelengths of light to determine the concentration level of oxygen in blood. Typically, pulse oximeters include a clamping probe that clamps around a translucent part of a patient's tissue, such as a finger. One side of the clamping probe includes light emitting diodes (LEDs) for emitting radiation at two distinct wavelengths towards the patient's tissue, and the other side of the clamping probe includes a photodiode aligned with the LEDs to receive the radiation that transmits through the patient's tissue. The amount of radiation for each wavelength that is received by the photodiode is measured.

Pulse oximeters distinguish between pulsating peripheral blood (AC components) and non-pulsating tissue (DC components). A ratio of the AC component of absorbency for each wavelength and the DC component of absorbency at each wavelength is then used to determine the peripheral oxygen saturation SpO₂ in the patient's blood using known radiation absorption levels of hemoglobin in blood.

In order to verify a pulse oximeter's operation, pulse oximeter testers have been used to test the quality or reliability of the measurements made by the pulse oximeter.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with aspects of the present disclosure, an apparatus for testing a pulse oximeter is provided. The apparatus may include a first photosensor and a first filter associated with the first photosensor. The first photosensor may be configured to receive first light pulses at a first wavelength and convert the first light pulses into a corresponding first electrical signal. The first filter may be configured to absorb and/or reflect at least some light at a second wavelength thereby preventing the first photosensor from receiving at least some of the light at the second wavelength. The apparatus may further include a second sensor and a second filter associated with the second photosensor. The second photosensor may be configured to receive second light pulses at the second wavelength and to convert the second light pulses into a corresponding second electrical signals. The second filter may be configured to absorb and/or reflect at least some light at the first wavelength thereby preventing the second photosensor from receiving at least some of the light at the first wavelength. The apparatus may further include electronic circuitry configured to receive the first electrical signal and second electrical signal and to produce a first electrical output signal and a second electrical output signal, respectively. The apparatus may further include a first light emitting diode and a second light emitting diode. The first light emitting diode may be configured to convert the first electrical output signals into third light pulses. The second light emitting diode may be configured to convert the second electrical output signal into fourth light pulses.

In accordance with aspects of the present disclosure, a system for testing a pulse oximeter is provided. The system may include a simulation sensor and a simulation controller coupled to the simulation sensor. The simulation sensor may comprise a first filter aligned with a first photodiode, a second filter aligned with a second photodiode, electronic circuitry, and a plurality of light emitting diodes. The first filter aligned with the first photodiode may be configured to receive first light pulses emitted from the pulse oximeter while filtering at least some visible light and to convert the received first light pulses into a first electrical signal. The second filter aligned with a second photodiode may be configured to receive second light pulses emitted from the pulse oximeter while filtering at least some infrared light and to convert the received second light pulses into a second electrical signal. The electronic circuitry may be configured to produce first and second output signals from the first and second electrical signals, respectively. The plurality of light emitting diodes may be configured to convert the first and second output signals into corresponding infrared signals and red signals. The simulation controller may be configured to control the electronic circuitry in response to various parameters for producing the first and second output signals.

In accordance with aspects of the present disclosure, a method of testing a pulse oximeter is provided. The method may include receiving from a pulse oximeter light pulses at a first wavelength while filtering at least some light at a second wavelength and receiving from the pulse oximeter light pulses at the second wavelength while filtering at least some light at the first wavelength. The method may further include converting the received light pulses at the first and second wavelengths into electrical signals. The method may further include converting the electrical signals into corresponding light pulses at the first wavelength and light pulses at the second wavelength. The method may further include emitting the converted light pulses at the first wavelength and the second wavelength toward the pulse oximeter.

### DESCRIPTION OF THE DRAWINGS

The foregoing aspects and many of the attendant advantages of this disclosure will become more readily appreciated or better understood by reference to the following detailed description, when taken in conjunction with the accompanying drawings, wherein:

FIG. 1 is a timing diagram of pulses generated by a pulse oximeter;

FIG. 2 is a block diagram of one example of a pulse oximeter test instrument associated with a pulse oximeter in accordance with aspects of the present disclosure;

FIG. 3 is an isometric view of a pulse oximeter test instrument in accordance with aspects of the present disclosure;

FIG. 4 is a circuit diagram of one example of a light detection system of a pulse oximeter test instrument in accordance with aspects of the present disclosure;

FIG. 5 is a timing diagram of pulses detected by a pulse oximeter test instrument in accordance with aspects of the present disclosure.

### DETAILED DESCRIPTION

While illustrative embodiments are illustrated and described below, it will be appreciated that various changes can be made therein without departing from the spirit and scope of the invention. In that regard, the detailed description set forth below, in connection with the appended drawings where like numerals reference like elements, is intended only as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result.

Embodiments of the present disclosure may be practiced with pulse oximeters. One example of a pulse oximeter includes a clamping probe for receiving a patient's tissue. The clamping probe includes light emitting diodes (LEDs) facing one or more photosensors, such as photodiodes. The one or more photodiodes are configured to receive the light emitted from the LEDs and convert the received optical signals into electrical signals. Typically, one or more of the LEDs of the clamping probe emit red light, having a wavelength of about 660 nanometers (nm), and one or more LEDs of the clamping probe emit infrared (IR) light, having a wavelength of about 940 nm. During use of the pulse oximeter, the red light and the IR light are alternatingly emitted from the LEDs through a translucent part of a patient's tissue, such as the patient's finger, to the photodiode(s).

It may be beneficial to test the quality or reliability of a pulse oximeter using an instrument referred to herein as a pulse oximeter test instrument. As will be explained below, examples of the pulse oximeter test instrument include a simulation sensor for simulating a patient's tissue, such as the patient's finger. In that regard, the simulation sensor may take the shape of a patient's finger such that a standard clamping probe of a pulse oximeter may be configured to clamp around a portion of the simulation sensor or may take other shapes that can suitably interface with presently available and future developed pulse oximeters. Although prior art pulse oximeter test instruments have assisted in testing the quality and/or reliability of a pulse oximeter, the inventor of the present application recognized that currently available pulse oximeter test instruments may lack precision and/or accuracy due to problems associated with currently available pulse oximeters, among others.

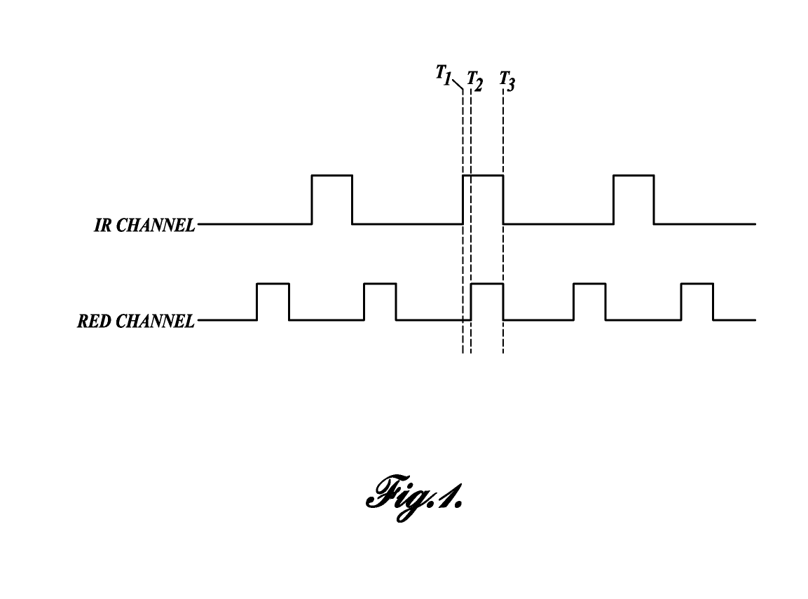

After testing various currently available pulse oximeters from a variety of vendors, the inventor discovered that occasionally some pulse oximeters emit a red light pulse and an IR light pulse at the same time. FIG. 1 is an example timing diagram illustrating a simultaneous IR pulse and red pulse generated in some pulse oximeters. It should be appreciated that the red pulses illustrated in FIG. 1 may be generated by one or more red LEDs and the IR pulses may be generated by one or more IR LEDs. Typically during use of the pulse oximeters, when the red LED is activated, the IR LED is inactivated and vice-versa, as illustrated by the first three pulses of FIG. 1. Between time T2 and T3, however, both the red LED and the IR LED are activated creating IR and red pulses at the same time. In particular, at time T1, the IR LED is activated creating an IR pulse. At time T2, before the IR LED is inactivated, the red LED is activated. At this time both the IR LED and the red LED are generating respective pulses. At time T3, both the IR LED and the red LED are inactivated. Some currently available pulse oximeters cause the IR LED to be activated the entire time during which the red LED is activated, or vice-versa.

In general, a pulse oximeter that simultaneously pulses red and IR light is counter intuitive as it is understood that current pulse oximeters are typically designed to sequentially or alternatingly pulse red light and IR light to a photosensor, such as the photodiode. However, when testing such pulse oximeters with prior art pulse oximeter test instruments, simultaneously pulsed red light and IR light produced inaccurate measurements by the pulse oximeter test instruments.

The following discussion provides examples of pulse oximeter test instruments that address the problem described above, among others. To that end, examples of pulse oximeter test instruments described below are configured to sense light at different wavelengths simultaneously. In some embodiments, pulses having an intensity above a particular threshold may be detected and used to test measurements made by a pulse oximeter. As such, the pulse oximeter test instruments disclosed herein are able to provide improved accuracy and more reliable test results over prior art pulse oximeter test instruments.

Although the pulse oximeter test instruments may be shown and described in reference to a simulated finger sensor, it should be appreciated that any simulation sensor may be used with the pulse oximeter test instruments described herein. In that regard, a simulation sensor may be used to simulate any tissue that may be used with a pulse oximeter, such as a patient's earlobe, toe, or the like.

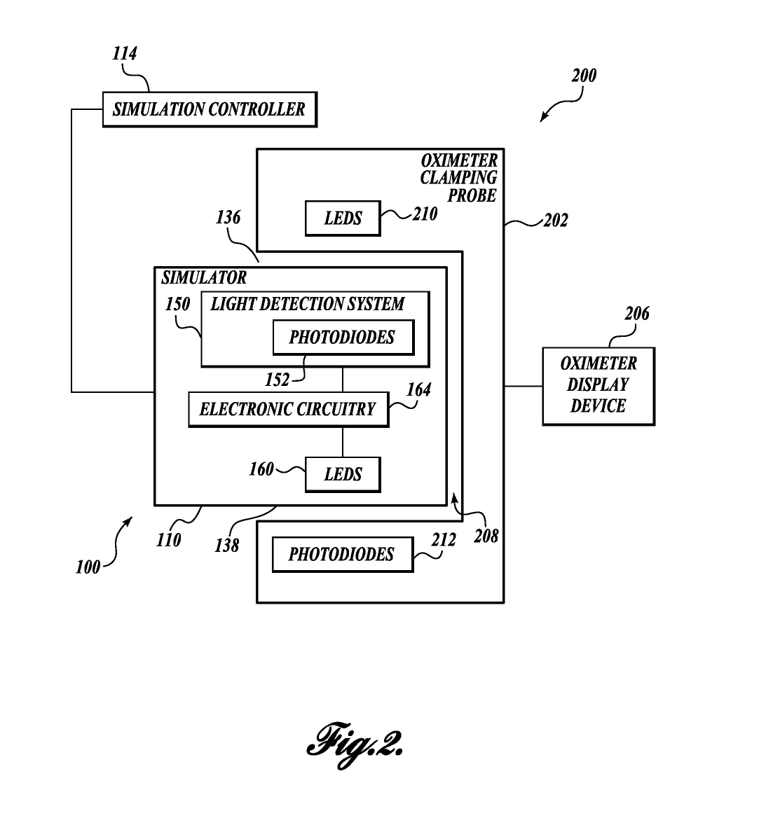

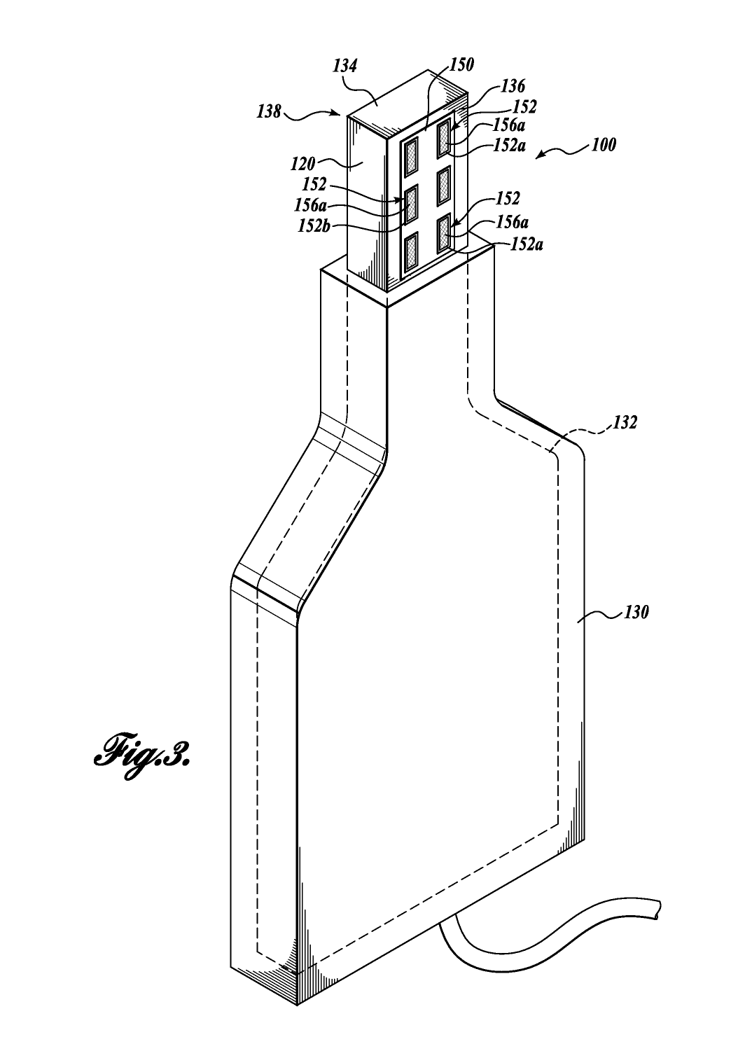

Turning now to FIGS. 2 and 3, there is shown a pulse oximeter test instrument 100 in accordance with aspects of the present disclosure. As will be explained in more detail below, the pulse oximeter test instrument 100 is configured to test an operation of a medical device, such as a pulse oximeter 200. In use, the pulse oximeter test instrument 100 is associated with a component, such as a clamping probe 202, of the pulse oximeter 200, as best illustrated by FIG. 2. In the illustrated embodiment, the pulse oximeter test instrument 100 includes a simulation sensor 110, such as a simulated finger sensor, coupled to a simulation controller 114. In some embodiments, the simulation controller 114 may be integral with the simulation sensor 110. Generally described, the simulation sensor 110 may be configured to simulate a patient's tissue, such as a patient's finger, to test the operation of the pulse oximeter 200. In that regard, the simulation sensor 110 may be configured to simulate absorption of radiation emitted from the pulse oximeter 200 in response to variations in parameters representative of tissue, such as size, color, shape, mass, density, blood flow etc., and the oxygen saturation in blood in such tissue. The simulation controller 114 may be configured to adjust various components within the simulation sensor 110 to simulate the various parameters during testing of the pulse oximeter 200.

In the illustrated embodiment and as briefly mentioned above, the pulse oximeter 200 includes a clamping probe 202 coupled to an oximeter display device 206, as best shown in FIG. 2. The clamping probe 202 includes an opening 208 for receiving a patient's tissue, such as the patient's finger, during normal operation of the pulse oximeter 200. As will be explained in more detail below, a portion of the simulation sensor 110 is suitably sized and shaped to be received within the opening 208 of the clamping probe 202. It should be appreciated that the clamping probe 202 includes suitable structure configured to clamp onto the simulation sensor 110 or the patient's tissue, such as a patient's finger.

Still referring to FIG. 2, one side of the clamping probe 202 includes LEDs 210 facing one or more photodiodes 212 located on the other side of the clamping probe 202. As briefly described above, one or more of the LEDs 210 emits red light, having a wavelength of about 660 nanometers (nm), and one or more LEDs 210 emit infrared (IR) light, having a wavelength of about 940 nm.

Turning now to FIG. 3, the simulation sensor 110 will be described in more detail. The simulation sensor 110 includes a substrate 120, such as a printed circuit board (PCB), partially surrounded by a housing 130. In the embodiment shown, the housing 130 surrounds a first portion 132 of the substrate 120 such that a second portion 134 of the substrate 120 extends from the housing 130. The housing 130 may be made of an insulative material, and in some embodiments, the housing 130 is opaque. The second portion 134 of the substrate 120 that extends from the housing 130 may be of a size and shape to simulate a patient's tissue, such as a finger. In this regard, the second portion 134 may be suitably configured to be inserted into the opening 208 of the clamping probe 202 of the pulse oximeter 200, as is best illustrated in FIG. 2.

Referring again to FIG. 3, the second portion 134 of the substrate 120 includes a light detection system 150 provided on a first surface 136. A second surface 138 opposite the first surface 136 may include a plurality of LEDs 160 mounted thereon as is best illustrated in FIG. 2. In some embodiments, the light detection system 150 includes at least one photosensor 152, such as photodiode 152a, configured to detect IR light emitted from LEDs of the pulse oximeter 200 and at least one photosensor 152, such as photodiode 152b, configured to detect red light emitted from the LEDs of the pulse oximeter 200. The photodiodes 152a and 152b are suitably positioned such that when the simulation sensor 110 is inserted into the opening 208 of the clamping probe 202 of the pulse oximeter 200, the photodiodes 152 of the simulation sensor 110 are aligned with or in proximity to the LEDs 210 of the clamping probe 202, and the LEDs 160 of the simulation sensor 110 are aligned with or in proximity to the photodiode 212 of the clamping probe 202, as best illustrated by FIG. 2. In that regard, the photodiodes 152 of the simulation sensor 110 are configured to receive light emitted from the LEDs 210 of the clamping probe 202 and the LEDs 160 of the simulation sensor 110 are configured to emit light to the photodiodes 212 of the clamping probe 202.

In operation, the light detected by the photodiodes 152 of the pulse oximeter test instrument 100 is converted to electrical signals and processed by the electronic circuitry 164 as specified by the simulation controller 114. Once processed, appropriate signals are then provided to the LEDs 160 and converted to optical signals. These optical signals are emitted by the LEDs 160 and detected by the photodiodes 212 of the pulse oximeter 200. For a description of circuitry that may be included or otherwise associated with the electronic circuitry 164, please see U.S. Pat. No. RE39,268 to Merrick et al., which is herein incorporated by reference for all purposes.

It will be appreciated that the substrate 120 may be of any material to sufficient support a plurality of electrical and optical components mounted thereon. The electrical and optical components mounted on the substrate 120 may be coupled together by traces formed within the substrate 120 as is well known in the art.

Referring again to FIG. 3, in the illustrated embodiment, the light detection system 150 includes a group of three photodiodes 152 configured to detect IR light referred to herein as IR photodiodes 152a, and a group of three photodiodes 152 configured to detect red light referred to herein as red photodiodes 152b. It should be appreciated that any number of photodiodes 152 may be used, however, including one IR photodiode 152a and one red photodiode 152b. In the embodiment shown, each IR photodiode 152a is aligned with an optical filter 156a configured to filter at least some red or visible light and each red photodiode 152b is aligned with an optical filter 156b configured to filter at least some IR light. The filters 156 may be in the form of tape, coating, glass, polymer, or any other optical filter aligned with, placed adjacent to, or formed on top of the photodiodes 152. In the event that the red LED 210 and the IR LED 210 of a pulse oximeter 200 are activated at the same time, the IR photodiodes 152a will receive the IR light and the red photodiode 152b will receive the red light. By using light detection system 150 configured to detect red light pulses while filtering out IR light pulses and vice-versa, the simulation sensor 110 disclosed herein is configured to more accurately simulate a patient's tissue and thus produce more reliable test results when used to test a pulse oximeter 200.

Although the filters 156 prevent undesirable light from entering a particular photodiode 152, it is possible that some red light may enter the IR photodiode 152a and some IR light may enter the red photodiode 152b. As will be explained in more detail below, some of the embodiments of the light detection system 150 further include threshold circuitry for detecting a pulse to prevent the light detection system 150 from detecting a red pulse by the IR photodiode 152a or vice-versa.

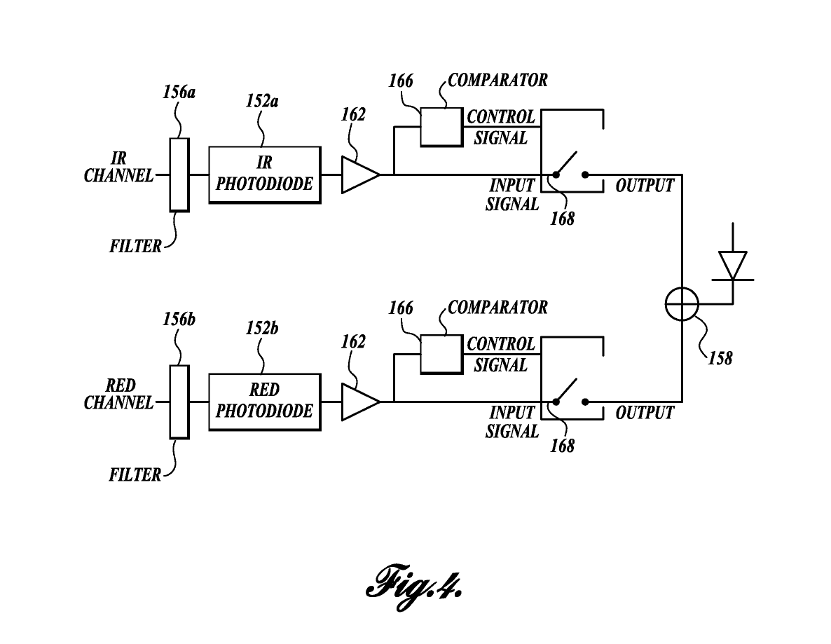

Turning now to FIG. 4, a schematic illustration of one example of the light detection system 150 of the simulation sensor 110 that includes the threshold circuitry will now be described. In the illustrated embodiment, the light detection system 150 includes two channels, an IR channel with an IR photodiode configured to receive IR light emitted from a pulse oximeter and a red channel with a red photodiode configured to receive red light emitted from the pulse oximeter. As will be explained in more detail below, the light detected by the two channels are converted to electrical signals and summed by a summing circuit 158. The summed electrical signals are provided to further electronic circuitry (not shown) for additional processing, if desired, and then transmitted to the LEDs 160 for emitting light to the photodiodes 212 of the pulse oximeter 200.

Each channel includes one or more filters 156 aligned with one or more photodiodes 152 configured to receive light emitted from the LEDs 210 of the pulse oximeter 200. In particular, the red channel includes a filter 156b configured to pass red light while reflecting and/or absorbing the IR light, and the IR channel includes a filter 156a configured to pass IR light while reflecting and/or absorbing visible light. An output of each of the photodiode groups 152a and 152b is coupled to an input of an operational amplifier 162 configured to amplify a signal output from the photodiode 152. An output of each amplifier 162 is coupled to an input of a comparator 166 and to a switch 168. Each corresponding switch 168 is controlled by a control signal output from the comparator 166.

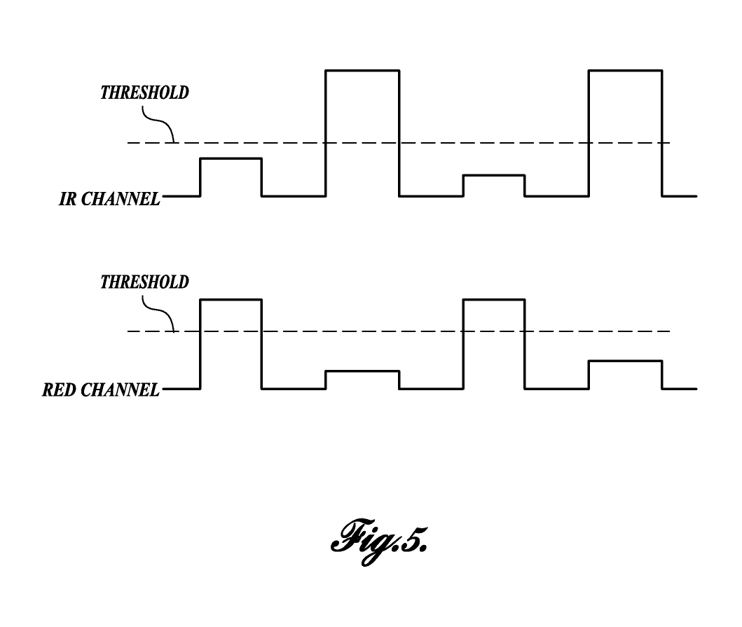

An operation of the light detection system 150 of the simulation sensor 110 having the threshold circuitry will now be described. Assuming that the pulse oximeter 200 emitted red light and IR light at approximately the same time as described above, the IR light and the red light is received by the red and IR channels. Referring first at the red channel, the filter 156b passes the red light while reflecting and/or absorbing most of the IR light. The red light is then received by the red photodiode 152b converted to an electrical signal. The electrical signal, after passing through the operational amplifier 162, is provided to the comparator 166. The comparator 166 compares an amplitude of the signal to a threshold value, as best illustrated in FIG. 5. If the amplitude of the signal is above the threshold value, the comparator 166 generates a control signal configured to close the switch 168 thereby transmitting the signal to the summing circuit 158. If the amplitude of the signal is below the threshold value, such as when some IR light passes through the filter 156b and is detected by the red photodiode 152b, the comparator 166 generates a control signal configured to open the switch 168 thereby preventing the signal from being transmitted to the summing circuit 158.

Referring now to the IR channel, the filter 156a passes the IR light while reflecting and/or absorbing most of the red light. The IR light is then received by the IR photodiode 152a and converted to an electrical signal. The electrical signal, after passing through the operational amplifier 162, is provided to the comparator 166. The comparator 166 compares an amplitude of the signal to a threshold value, as shown in FIG. 5. If the amplitude of the signal is above the threshold value, the comparator 166 generates a control signal configured to close the switch 168 thereby transmitting the signal to the summing circuit 158. If the amplitude of the signal is below the threshold value, such as when some red light passes through the filter 156a and is detected by the IR photodiode 152a, the comparator 166 generates a control signal configured to open the switch 168 thereby preventing the signal from being transmitted to the summing circuit 158.

By preventing the signal from being transmitted to the summing circuit 158, the light detection system 150 in these embodiments is able to prevent pulses of red light that pass through the filter 156a and detected by the IR photodiode 152b and to prevent pulses of IR light that pass through the filter 156b and detected by the red photodiode 152b from being processed by the electronic circuitry 164. Thus, the pulse oximeter test instruments 100 disclosed herein are able to produce more accurate and reliable results when testing a pulse oximeter 200.

Various principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the claimed subject matter.

The embodiments of the disclosure in which an exclusive property or privilege is claimed are defined as follows:

1. An apparatus for testing a pulse oximeter, the apparatus comprising:
a first photosensor configured to receive first light pulses at a first wavelength and convert the first light pulses into a corresponding first electrical signal;
a first filter associated with the first photosensor, wherein the first filter is configured to absorb and/or reflect at least some light at a second wavelength thereby preventing the first photosensor from receiving at least some of the light at the second wavelength;
a second photosensor configured to receive second light pulses at the second wavelength and to convert the second light pulses into a corresponding second electrical signals
a second filter associated with the second photosensor, wherein the second filter is configured to absorb and/or reflect at least some light at the first wavelength thereby preventing the second photosensor from receiving at least some of the light at the first wavelength;
electronic circuitry configured to receive the first electrical signal and second electrical signal and to produce a first electrical output signal and a second electrical output signal, respectively;
a first light emitting diode configured to convert the first electrical output signals into third light pulses; and
a second light emitting diode configured to convert the second electrical output signal into fourth light pulses.

2. The apparatus of claim 1, further comprising a comparator configured to compare the first electrical signal with a threshold value, wherein in response to the first electrical signal being above the threshold value, the comparator generating a control signal configured to close a switch thereby transmitting the first electrical signal to the electronic circuitry.

3. The apparatus of claim 2, wherein in response to the first electrical signal being below the threshold value, the comparator generating a control signal configured to open the switch thereby prohibiting transmission of the first electrical signal to the electronic circuitry.

4. The apparatus of claim 2, wherein the comparator is a first comparator and wherein the apparatus further comprises a second comparator configured to compare the second electrical signals with a second threshold value, wherein in response to the second electrical signal being above the second threshold value, the comparator generating a control signal configured to close a switch thereby transmitting the second electrical signal to the electronic circuitry.

5. The apparatus of claim 4, wherein in response to the second electrical signal being below the second threshold value, the comparator generating a control signal configured to open the switch thereby prohibiting transmission of the second electrical signal to the electronic circuitry.

6. The apparatus of claim 1, wherein the first wavelength is within a range of infrared light and the second wavelength is within a range of red light.

7. A system for testing a pulse oximeter, the system comprising:
a simulation sensor comprising:
a first filter aligned with a first photodiode configured to receive first light pulses emitted from the pulse oximeter while filtering at least some visible light and to convert the received first light pulses into a first electrical signal;
a second filter aligned with a second photodiode configured to receive second light pulses emitted from the pulse oximeter while filtering at least some infrared light and to convert the received second light pulses into a second electrical signal;
electronic circuitry configured to produce first and second output signals from the first and second electrical signals, respectively; and
a plurality of light emitting diodes configured to convert the first and second output signals into corresponding infrared signals and red signals; and
a simulation controller coupled to the simulation sensor, the simulation controller configured to control the electronic circuitry in response to various parameters for producing the first and second output signals.

8. The system of claim 7, wherein the simulation sensor further comprises a comparator configured to compare the first electrical signal to a threshold value, and in response to the first electrical signal being above the threshold value, closing a switch thereby transmitting the first electrical signal to the electronic circuitry.

9. The system of claim 7, wherein the simulation sensor further comprises a comparator configured to compare the second electrical signal to a threshold value, and in response to the second electrical signal being above the threshold value, closing a switch thereby transmitting the second electrical signal to the electronic circuitry.

10. The system of claim 7, wherein the first light pulses have a wavelength in an infrared range and the second light pulses having a wavelength in a visible light range.

11. The system of claim 7, wherein the simulation controller is integral with the simulation sensor.

12. A method of testing a pulse oximeter, the method comprising:
receiving from a pulse oximeter light pulses at a first wavelength while filtering at least some light at a second wavelength;
receiving from the pulse oximeter light pulses at the second wavelength while filtering at least some light at the first wavelength;
converting the received light pulses at the first and second wavelengths into electrical signals;
converting the electrical signals into corresponding light pulses at the first wavelength and light pulses at the second wavelength; and
emitting the converted light pulses at the first wavelength and the second wavelength toward the pulse oximeter.

13. The method of claim 12, further comprising comparing the electrical signals to a threshold value and in response to an electrical signal being above the threshold value, transmitting the electrical signal for conversion into corresponding light pulses.

14. The method of claim 13, wherein comparing the electrical signals to a threshold value comprises comparing an amplitude of the electrical signal to the threshold value.

15. The method of claim 13, further comprising in response to an electrical signal being below the threshold value, preventing the electrical signal from being transmitted for conversion into corresponding light signals.

16. The method of claim 12, wherein the first wavelength is within an infrared region of light.

17. The method of claim 16, wherein the first wavelength is approximately 940 nanometers.

18. The method of claim 12, wherein the second wavelength is within a visible range of light.

19. The method of claim 18, wherein the second wavelength is approximately 660 nanometers.
